(19) United States
(12) Patent Application Publication
(10) Pub. No.: US 2026/0179993 A1
(43) Pub. Date: Jun. 25, 2026

(54) FRAME DEVICE FOR A PROPULSION UNIT OF A FLIGHT DEVICE

(71) Applicant: H3 DYNAMICS HOLDINGS PTE. LTD., Singapore (SG)

(72) Inventors: Taras Elie WANKEWYCZ, Singapore (SG); Bertrand; GAUTHIER, Paris (FR); Augustus YIP, Singapore (SG); Mark SHUCK, Singapore (SG); Quentin BARASCUD, Singapore (SG)

(21) Appl. No.: 19/125,182

(22) PCT Filed: Oct. 28, 2023
(86) PCT No.: PCT/IB2023/060875

§ 371 Date: Apr. 28, 2025

(30) Foreign Application Priority Data
Oct. 28, 2022 (SG) 10202251522Q

(51) Int. Cl. H01M 8/248

(52) U.S. Cl. CPC H01M 8/248

(57) ABSTRACT

A frame device for a propulsion unit of a flight device, comprises annular elements for a fixation of a fuel tank of the propulsion unit, a retaining element being arranged between at least two of the annular elements for bearing an electrical energy storage and a fuel cell stack of the propulsion unit, fixing elements for fixing the annular elements in a longitudinal alignment of the frame device, and a mounting device being fixed to at least one of the fixing elements for mounting the frame device to a main lifting surface of the flight device. By means of the frame device a simple and stable mounting of components of a propulsion unit for the flight device is supported.

### CROSS REFERENCE TO RELATED APPLICATIONS

The present application is a U.S. National Phase of International Application No. PCT/IB2023/060875 entitled “FRAME DEVICE FOR A PROPULSION UNIT OF A FLIGHT DEVICE,” and filed on Oct. 28, 2023. International Application No. PCT/IB2023/060875 claims priority to Singapore Patent Application No. 10202251522Q filed on Oct. 28, 2022. The entire contents of each of the above-listed applications are hereby incorporated by reference for all purposes.

### TECHNICAL FIELD

The present disclosure relates to a frame device for a propulsion unit of a flight device.

BACKGROUND AND SUMMARY The proposed frame device can e.g. be used for propulsion units for unmanned aerial vehicle (multi-rotors, single-rotors, VTOL, hybrid-VTOL, fixed-wings, vertically launched unmanned vehicles, horizontally launched unmanned vehicles, catapult assisted launched unmanned vehicles, etc.) powered by a network of hydrogen-electric propulsion pods distributed along the of the aircraft.

EP 4 032 811 A1 discloses an aircraft propulsion module, wherein the propulsion module contains different components and comprises at least one separation means adapted to separate at least one component of the propulsion module from the propulsion module.

It is an object of the present application to provide an improved frame device for a propulsion unit of a flight device.

In one aspect of this specification, there is provided a frame device for a propulsion unit of a flight device, comprising:
annular elements for a fixation of a fuel tank of the propulsion unit;
a retaining element being arranged between at least two of the annular elements for bearing an electrical energy storage and a fuel cell stack of the propulsion unit;
fixing elements for fixing the annular elements in a longitudinal alignment of the frame device; and
a mounting device being fixed to at least one of the fixing elements for mounting the frame device to a main lifting surface of the flight device.

A preferred embodiment of the frame device is characterized in that between at least two of the annular elements being arranged side by side foam material is arranged. In this way, a fuel tank can be vibration-mounted within the frame device.

A further preferred embodiment of the frame device comprises cowling elements by means of which the propulsion unit inside the frame structure is coverable. A stiffness of the frame device and the propulsion unit is supported in this way. Furthermore, components of the propulsion unit are protected against external influences.

A further preferred embodiment of the frame device is characterized in that the annular elements and the retaining elements are at least partially fixed by means of substance-to-substance bond. In this way, a great stiffness and stability of the frame device is supported.

A further preferred embodiment of the frame device is characterized in that the substance-to-substance bond is realized by welding fastening and/or gluing.

A further preferred embodiment of the frame device is characterized in that at least some of the elements comprise of aluminum, glass or carbon composite material. A lightweight and durable construction of the frame device is thus obtained.

A further preferred embodiment of the frame device is characterized in that the retaining element is arranged between a motor and the fuel cell stack of the propulsion unit. By means of this specific arrangement of the retaining element, a protection of the fuel cell stack is supported.

A further preferred embodiment of the frame device is characterized by rail elements being arranged between at least some of the annular elements in a front section of the frame device, by means of which the electrical energy storage and/or the fuel cell stack are arrangeable inside the frame device.

A further preferred embodiment of the frame device further comprises a fixing strap for fixing the fuel tank of the propulsion unit inside the frame device. Industry, a stable arrangement of the fuel tank within the frame device is supported.

A further preferred embodiment of the frame device is characterized in that it further comprises an arrangement of an electronic speed control, ESC, arming switch of the propulsion unit. This could be realized e.g. by means of an opening in one of the fixing elements.

A further preferred embodiment of the frame device is characterized in that the mounting device comprises flat elements on top being shaped essentially parallel to a surface of the cowling elements.

A further preferred embodiment of the frame device is characterized in that the mounting device is made of aluminum, steel, glass or carbon composite material.

A further preferred embodiment of the frame device is characterized in that a pressure regulator is arrangeable rearwards at at least one of the annular elements of the frame device.

Other objects and advantages of the proposed frame device will become apparent from the following description, taken in connection with the accompanying drawings. By way of illustration and example, several embodiments and applications of the proposed frame device are disclosed.

The drawings are schematically and show principles of the proposed frame device and propulsion units, arrangements of the frame device with the propulsion units being mountable on at least a wing of an aircraft. All drawings are not necessarily true-to-scale.

In the following description, like reference signs designate like or corresponding parts throughout several views of the drawings.

Some parts of embodiments, which are shown in the figures, have similar parts. The similar parts have the same names or similar part numbers with a prime symbol or with an alphabetic symbol. The description of such similar parts also applies by reference to other similar parts, where appropriate, thereby reducing repetition of text without limiting the disclosure.

### BRIEF DESCRIPTION OF THE FIGURES

FIG. 1 is a perspective view of a propulsion unit being mounted under usage of the proposed frame device;

FIG. 2 is a perspective view of a proposed frame device with components of a propulsion unit;

FIG. 3 is a further perspective view of a proposed frame device with components of a propulsion unit;

FIG. 4 is a perspective view of a propulsion unit being mounted under usage of a proposed frame device;

FIG. 5 is a detail view of FIG. 4;

FIG. 6 is a further detail view of FIG. 4;

FIG. 7 is a rear view of a propulsion unit;

FIG. 8 is a side view of a propulsion unit;

FIG. 9 is a frontal view of a propulsion unit;

FIGS. 10-12 are perspective views of a propulsion unit;

FIGS. 13-15 are side views of propulsion units;

FIG. 16 shows an arrangement of a propulsion unit being mounted to a wing of an aircraft;

FIG. 17-20 show arrangements of propulsion units being mounted to wings of an aircraft.

### DETAILED DESCRIPTION

The term “flight device” as used hereinafter may refer to various aircrafts and flight devices, which can preferably be realized as unmanned aerial vehicles (UAV, drones). However, needless to say that in the context of the present application, flight devices are not limited to any particular or specific type of flight device.

It should be noted that the following detailed description is directed to an exemplary frame device and is not limited to any particular size, form or configuration but in fact encompasses a multitude of sizes, forms and configurations of frame devices within the scope of the following description.

The present disclosure relates to the field of electrically powered unmanned vehicles whereas unmanned vehicles needs to be powered by electrical motors. More specifically, this disclosure relates to a new type of unmanned aerial vehicles whereas the unmanned aerial vehicle is powered by distributed hydrogen-electric propulsion nacelles and transports a payload in the central fuselage or by additional distributed pods.

Unmanned aerial vehicle powered by one or more hydrogen-electric propulsion units (pods) or nacelles. The propulsion unit or nacelle consists of a nacelle with a shell designed for optimized air inlet and outlet for cooling of components, and a fuel cell system oxygen source.

The propulsion unit comprises a motor, controller and propeller with the option of having a puller propeller and a pusher propeller, or a tilt rotors that turns up and down to manage several flight phases from horizontal cruise to vertical landing.

The propulsion unit comprises a fuel cell system that converts hydrogen into electricity and a hybrid electric sources such as a battery or a supercapacitor, including an electronic card and controller balancing the power supply sources.

The propulsion unit comprises a compressed hydrogen gas storage cylinder or a compressed hydrogen gas buffer tank for the boil-off from a centralized liquid hydrogen storage stored in the central part of the fuselage, or a liquid hydrogen storage tank.

The propulsion unit may be equipped with a solenoid valve connected to the pressure regulator mounted on a hydrogen cylinder that opens when an emergency landing is programmed in order to quickly release hydrogen outside and venting.

An energy management system manages the distribution of hydrogen and the distribution of power from different power sources including fuel cell systems, batteries, supercapacitors, according to the power requirements of the electric load comprising the motor and auxiliaries.

A distributed electric propulsion management system manages the command and control of the distributed electric motors.

The propulsion unit may comprise an ESC arming switch, command and control buttons, battery and fuel cell compartments with sliding locking mechanical parts, a telemetry antenna to communicate subsystems' parameters data.

The wing to pod connection is aerodynamically shaped with a quick release mechanism by means of a sliding locking mechanical part. The connection can also be achieved by means of bolts and nuts, which is a solution simpler to implement, but requires a longer time to attach and remove the pod.

The wing to pod connection comprises a reinforced rib inside the wing to manage the additional load from the pod.

The UAV may comprise at least one of the following components: a cargo bay to store a payload, an avionics bay, a parachute connected to a Flight Termination System, landing gear or landing skid, vertical lift rotors.

The present application relates preferably to the field of electrically powered unmanned aerial vehicles, whereby the electrically powered unmanned vehicles need to be powered by electric motors. More specifically, a propulsion unit being mounted by means of the proposed frame device can drive unmanned aerial vehicles whereas the unmanned aerial vehicle is powered by distributed hydrogen-electric propulsion nacelles and transports a payload.

Unmanned aerial vehicles (e.g. drones) are preferably used to perform data collection or cargo transportation mission. The vast majority of civilian drones are powered by electric propulsion with battery as a main storage device. However, current batteries are rather heavy compared to the amount of energy they can carry. Thus, conventional electric drones have limited range and endurance. Hydrogen electric propulsion where hydrogen is stored in gaseous or liquid form in a specific container and then converted to electricity via a fuel cell system offer the opportunity to increase the amount of energy carried on-board while minimizing the increase in weight. This opens new opportunities for long range or long endurance missions. Hydrogen-electric propulsion requires specific equipment and integration actions to allow the drone to operate safely and meet the required performances.

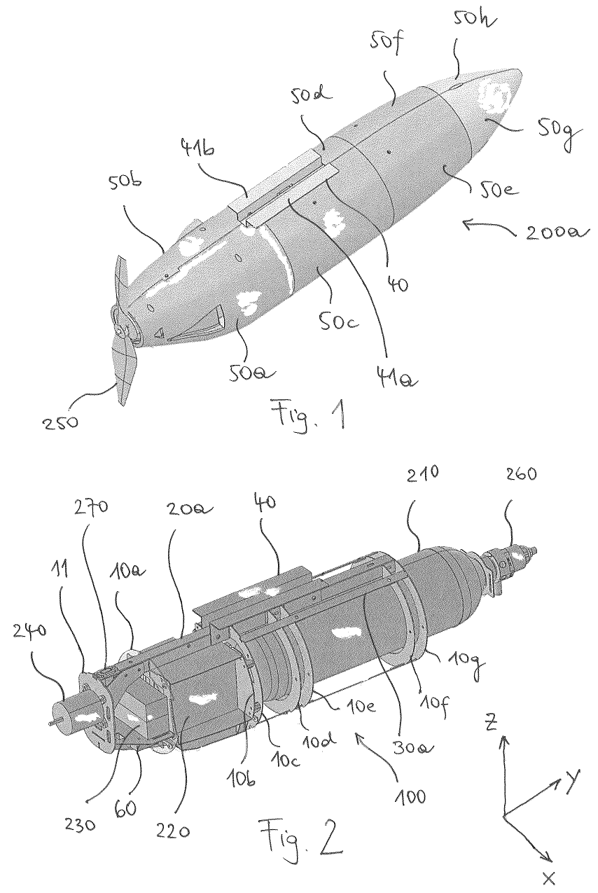

Referring to FIG. 1 now, one recognizes a propulsion unit 200a having typically less than 1 kW cruise power. The propulsion unit 200a comprises an electric motor 240 which drives a propeller 250. The propulsion unit 200a is assembled by means of an embodiment of the proposed frame device 100 (not shown). One recognizes horizontal sections 41a, 41b of a mounting device 40 on top by means of which the frame device 100 can easily be mounted to a wing or fuselage of a flight device (not shown). Said mounting device 40 can preferably be made of aluminum. One recognizes further cowling elements 50a . . . 50n which cover the frame device 100.

The propulsion unit 200a further comprises a controller and optionally a puller propeller, a pusher propeller or tilt rotors (not shown) that rotates up and down to manage several flight phases from horizontal cruise to vertical landing of the flight device.

The outer shell of the propulsion unit 200a formed with cowling elements 50a . . . 50n acts as a cover to protect the internal components from the environment. Advantageously, the stiffness of the propulsion unit 200a . . . 200n can be increased in this way. For propulsion systems of less than or equal to 1 kW power output, the outer shell is not a structural component and will only need to resist aerodynamic loads. Back cowling elements 50g, 50h can be removed to easily refill onboard or remove the hydrogen storage unit using a hinge system (not shown). Quick access hatches are incorporated into the forward cowling elements at strategic locations e.g. near the battery bay to facilitate access to these areas for quick operations, eliminating the need to remove the cowlings during regular operations.

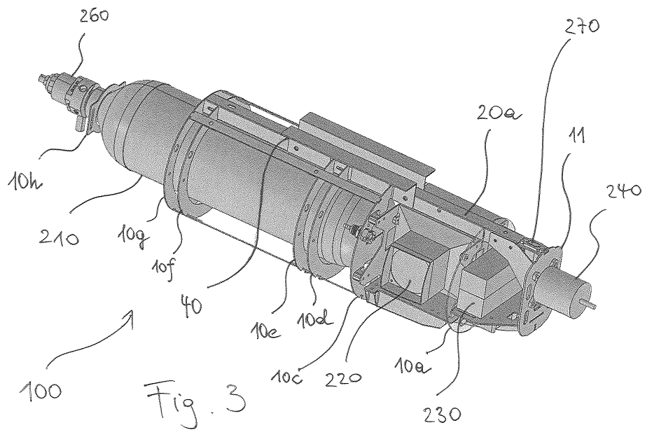

FIG. 2 show main structural components of the proposed frame device 100 and the propulsion unit 200a. One recognizes a bulkhead 11, a fixing element formed as a top rail 20a, annulare frame elements 10a . . . 10n being fixed by means of the fixing elements 20a . . . 20n and stringer elements 30a. At least some of the elements 10a . . . 10n, 20a . . . 20n, 30a . . . 30n are preferably be made of carbon fiber composite plates or aluminum. Structures to secure a cylindric fuel tank 210 of the propulsion unit 200a are arranged between the annular elements 10d, 10e and 10f, 10g, respectively, are preferably made of a foam material. The mounting device 40 is used to attach the arrangement of the frame device 100 with the propulsion unit 200a to a flight device (not shown) and can e.g. be made of aluminum.

A foam cylinder support surrounds the fuel tank 210 to hold it in place along with fixing straps (e.g. velcro straps, not shown) and annular elements 10a . . . 10n provides a safe and convenient way to remove the cylindric fuel tank 210 easily. The cylindric fuel tank can be removed by unstrapping the straps and sliding it out of the foam cylinder support and annular elements 10a . . . 10n. The fuel tank 210 is placed with a pressure reducer 260 facing backward for safety and refilling access. By means of the pressure reducer 260 the fuel cell 220 can be supplied with ambient air with suitable pressure via an air tube (not shown).

The top rail 20a is one of the main structural elements of the frame device 100. It transfers the load to the wing via the mounting device 40. The bulkhead 11 and its brackets transfer the load from the motor 240 to the top rail 20a. The electrical energy storage 230 is installed onto a retaining element 60 with a plate and held in place by a bracket and fixing straps. The fuel cell 220 is installed onto the annular elements 10a, 10b, which are attached to the top rail 20a. Two guide rails (not shown) being attached onto the frames enable an easy installation and removal of the fuel cell 220 by sliding on them to ensure proper alignment. In this way an easy removal of components of the propulsion unit 200a is supported.

Between at least two of the annular elements 10a . . . 10n there is arranged a foam material. In this way, the cylindric fuel tank is damped mounted inside the frame device 100.

One recognizes, that the retaining element 60 is arranged between the bulkhead 11 and the fuel cell stack 220. Furthermore, in this way, the electric energy storage 230 is located near the center of gravity of the flight device 300. It is preferred, to attach the propulsion unit 200a . . . 20n to a main lifting surface 310 of a flight device 300 near a longitudinal center of gravity.

The top rail 20a and the retaining element 60 are connected to the motor bulkhead 11 to form a materially bonded groove plug connection, wherein the groove plug connection can be realized as a welded connection and/or as an adhesive connection. The plate element of the retaining element 60 serves as a support of an electrical energy storage 230. Several types and sizes of electrical energy storages 230 (e.g. batteries) can be used.

One recognizes further an opening in a fixing element 20a for an arrangement of an ESC arming switch 270 of the propulsion unit 200a. By means of the ESC arming switch 270 a pilot of the flight device 300 driven by the propulsion unit 200a can disable power supply to the motor 240 from external and does not need to use a corresponding controller. A safe operation and switch off of the electric motor 240 is supported in this way.

At least some of the elements 10a . . . 10n, 20a . . . 20n ,30, 40 are of carbon composite material, which supports a light and stable design of the frame device 100. These could also be made from aluminum, titanium or other light weight material.

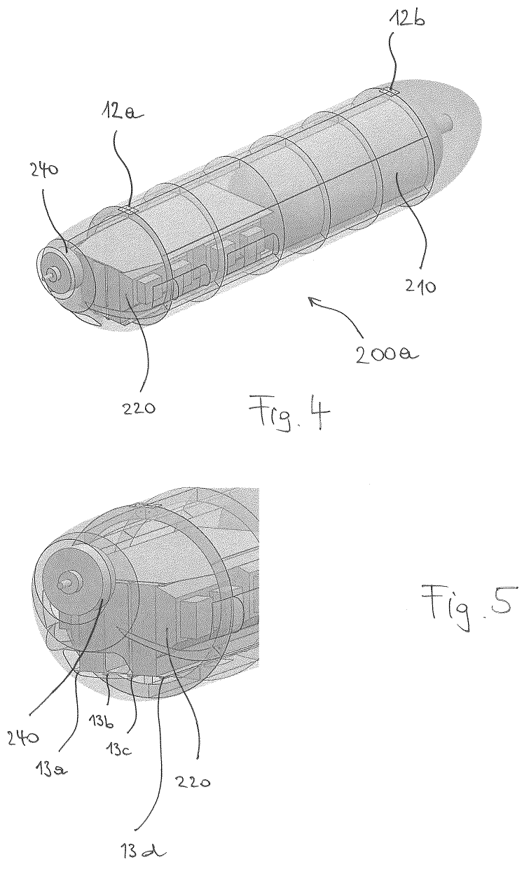

FIG. 3 shows a perspective view of the frame device 100 of FIG. 2 in a reverse orientation (seen from right hand side in flight direction).

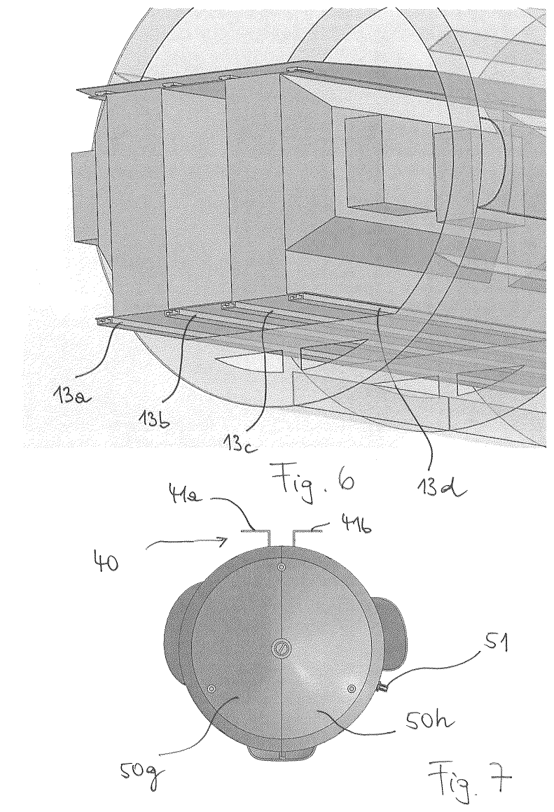

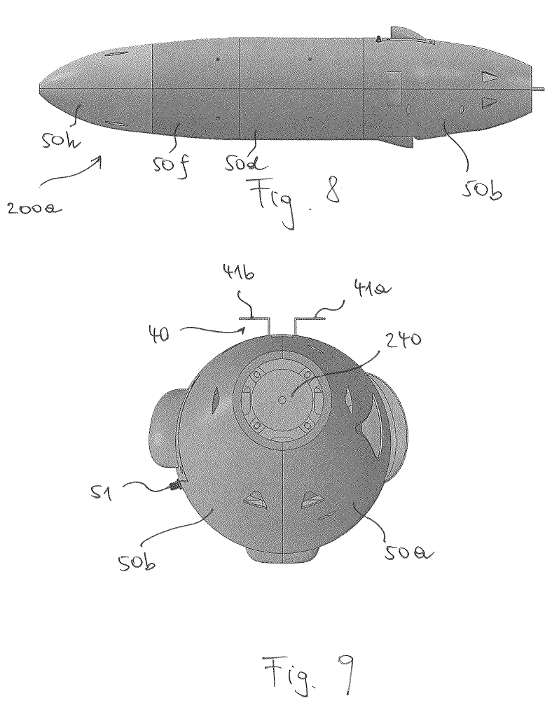

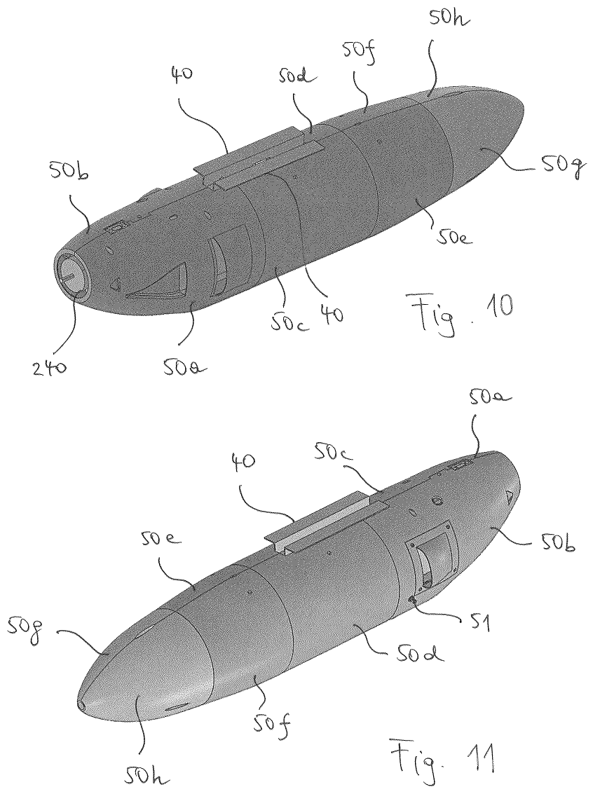

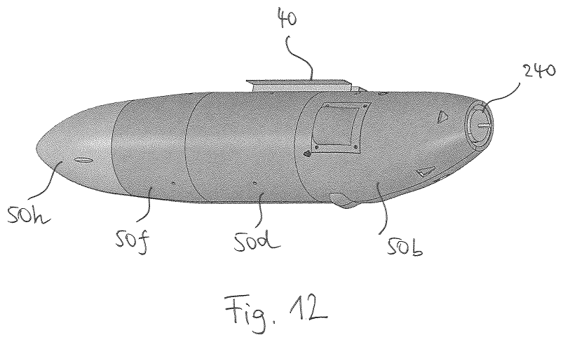

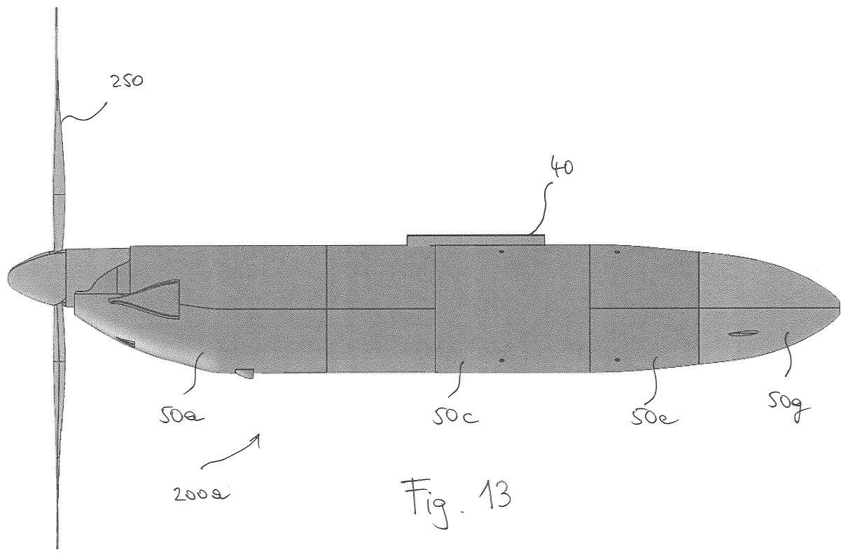

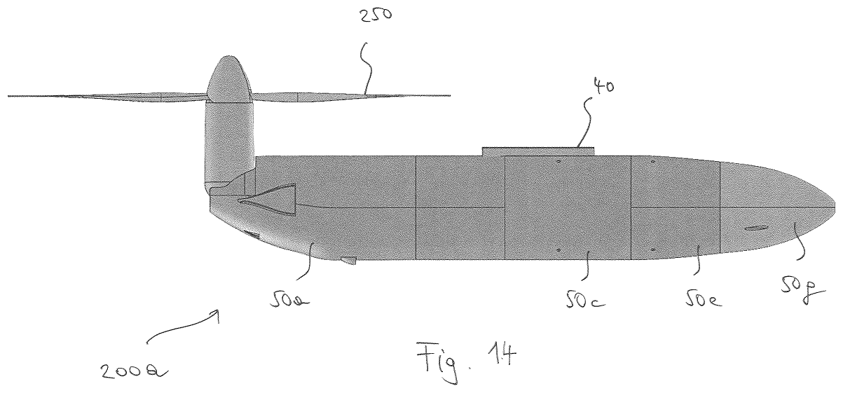

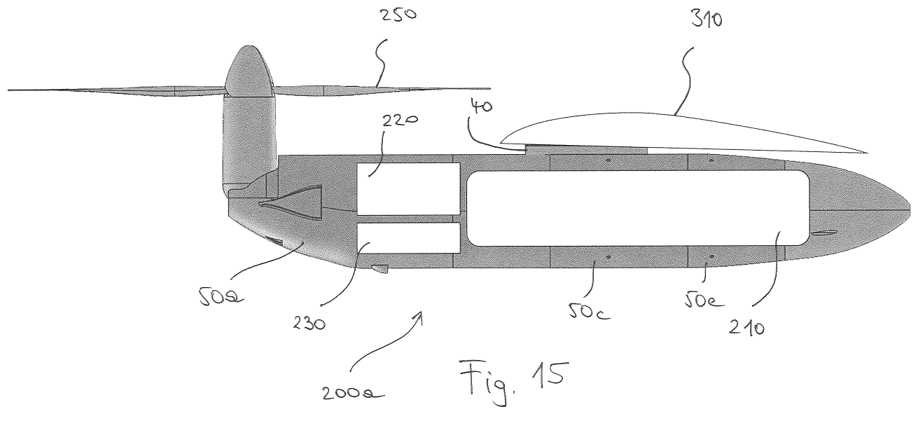

FIG. 4 shows an arrangement for a propulsion unit structure having a cruise power greater than 1 kW. For such propulsion systems, the outer shell carries structural loads. To get access to the fuel cell 220 and the cylindric fuel tank 210 easily, the outer shell is split into three portions, forward portion, middle portion and after shell portion. The forward and after shell portions are then attached to the middle shell portion via hinges 12a, 12b, to facilitate ground operations, and screws to ensure proper load transfer.

To ensure that the fuel cells 220 of the propulsion unit 200a are well secured during operation and at the same time easily removable for maintenance, they can be arranged onto rail elements 13a . . . 13d, from which they can slide on and off easily. These rail elements 13a . . . 13d are installed onto the middle shell structure, as shown in FIG. 5, which is a detail view of FIG. 4.

Air inlets and outlets 51 are installed to manage airflows supplying oxygen to the fuel cell stack 220 and cooling of the components. Air inlets can be designed using NACA-shapes and other duct designs to minimize induced drag.

FIG. 6 is a further detail view of FIG. 4 and shows the front section of the frame device 100 with the propulsion unit. One recognizes rail elements 13a . . . 13d, by means of which the fuel cell stack 220 and the electric energy storage 230 can be put on off into the frame device 100. Preferably, the rail elements 13a . . . 13d are built as ball bearing rail elements.

FIG. 7 is a rear side view of the propulsion unit. One recognizes the flat portions 41a, 41b of the mounting device 40 and 40, by means of which the propulsion unit can easily be attached to a wing of a flight device. An air inlet 51 is used for the supply of air to the pressure regulator (not shown). Cowling elements 50g, 50h can easily be detached and support in this way a quick and comfortable component replacement of the propulsion unit.

FIGS. 8 to 12 show different views of a propulsion unit 200a being mounted by means of the proposed frame device 100.

FIG. 13 to 15 show views of further embodiments of the proposed propulsion unit 200a. FIG. 13 shows a propulsion unit with a propeller 250 for a horizontal flight of the flight device.

FIG. 14 shows a propulsion unit 200a with a propeller 250 for a vertical flight of the flight device.

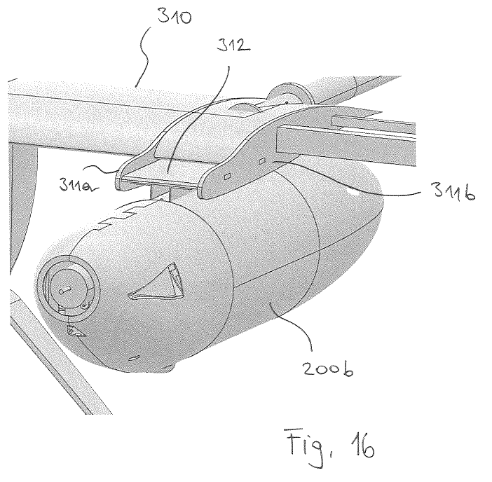

FIG. 15 shows a propulsion unit 200a with a schematized representation of main components, such as a fuel tank 210, an electric energy storage 230 and a fuel cell stack 220. One recognizes, that by means of the mounting device 40 the propulsion unit 200a is attached to a main lifting surface 310 of an aircraft with a propeller 250 for a vertical flight of the flight device.

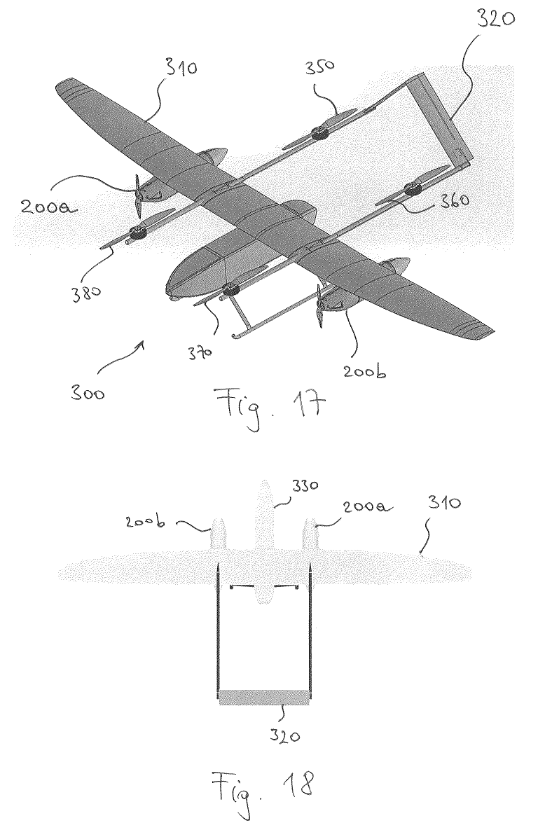

FIG. 16 shows an exemplary arrangement of a propulsion unit 200b being mounted to a main lifting surface 310 of a flight device 300. In order to attach and detach the propulsion unit 200b quickly and at the same time, to ensure that it is sufficiently robust to power the flight device 300, two reinforced ribs 311a, 311b are mounted at the main lifting surface 310. Furthermore, a flat plate 312 is installed between the ribs 311a, 311b to provide a rigid structure to mount the propulsion unit 200b. The propulsion unit 200b can then be attached to the plate 312 by e.g. four screws. This design results in a quick and efficient method to attach and detach a propulsion unit, using a standard screwdriver, wherein no special tools are required. Needless to say, that there exist various alternative possibilities to implement a fixation of the propulsion unit 200b to a main lifting surface 310 of a flight device 300 which are not explained hereinafter.

In this way, and easy and fest mount/removal of the propulsion unit 200b on the flight device 300 is supported.

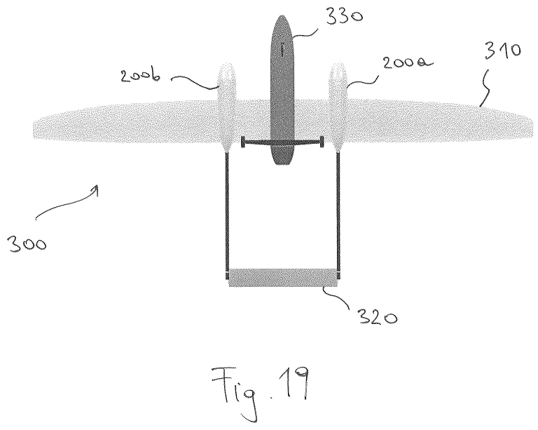

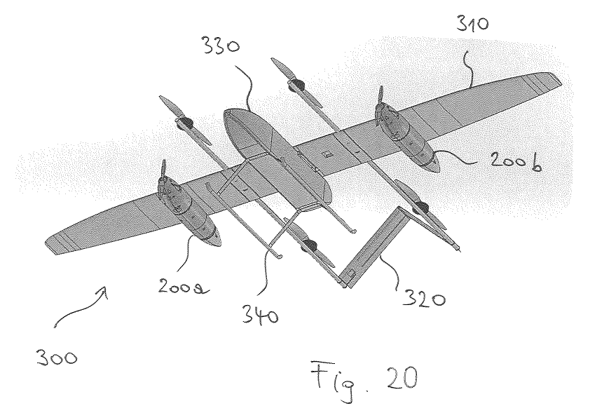

FIGS. 17 to 20 show different views of flight devices 300 with propulsion units 200a, 200b assembled by means of the proposed frame device 100 in different views.

The FIGS. 17 to 21 show a flight device 300 being driven by two propulsion units 200a, 200b horizontally and by four propellers 350, 360, 370, 380 vertically. Electric motors of said propellers are supplied with electric energy by the propulsion units 200a, 200b via power cables (not shown).

One can see that the flight device 300 formed as an UAV is powered by a network of several hydrogen-electric propulsion units 200a . . . 200n distributed along lifting surfaces 310, 320 of the flight device 300. The number of propulsion units 200a . . . 200n can preferably be two, four, six, eight, ten, twelve or another number.

The flight device 300 comprises at least one main lifting surface 300 (wing) and a tail lifting surface 320 which can be of different types, e.g. Inverted-V, conventional, cruciform, T-shape, V-shape, H-shape, etc.

The flight device 300 comprises a fuselage 330 with a cargo bay to transport payloads, an avionics bay, a parachute linked to a flight termination system.

The propulsion units 200a, 200b are connected to the main lifting surface 310 via reinforced ribs integrated into the main lifting surface 310.

The flight device 300 may have landing gears 340 for conventional take-off and landing, a nosewheel can be controllable. The aircraft 300 can be either remotely piloted or autopiloted. It can be dismantled to facilitate transport operations. The main lifting surface 310 has three parts including a central panel and two side panels.

The flight device 300 can also include a vertical take-off and landing capability which consists of tilting rotors mounted onto the propulsion pods or four rotors mounted as a quadcopter onto the booms of the UAV. The UAV comprises landing skid.

A person skilled in the art will recognize that numerous variations of the proposed liquid fluid dispenser are possible which are not or at least not fully disclosed hereinbefore.

### Itemized List of Embodiments

The following is a list of embodiments:
1. Frame device (100) for a propulsion unit (200a . . . 200n) of a flight device (300), comprising:
   annular elements (10a . . . 10n) for a fixation of a fuel tank (210) of the propulsion unit (200a . . . 200n);
   a retaining element (60) being arranged between at least two of the annular elements (10a . . . 10n) for bearing an electrical energy storage (230) and a fuel cell (220) of the propulsion unit (200a . . . 200n);
   fixing elements (20a . . . 20n) for fixing the annular elements (10a . . . 10n) in a longitudinal alignment of the frame device (100); and
   a mounting device (40a, 40b) being fixed to at least one of the fixing elements (20a . . . 20n) for mounting the frame device (100) to a main lifting surface (310) of the flight device (300).
2. Frame device (100), characterized in that between at least two of the annular elements (10a . . . 10n) being arranged side by side foam material is arranged.
3. Frame device (100), further comprising cowling elements (50a . . . 50n) by means of which the propulsion unit (200a . . . 200n) inside the frame structure (100) is coverable.
4. Frame device (100), characterized in that the annular elements (10a . . . 10n) and the retaining elements (20a . . . 20n) are at least partially fixed by means of substance-to-substance bond.
5. Frame device (100), characterized in that the substance-to-substance bond is realized by welding, fastening and/or gluing.
6. Frame device (100), characterized in that at least some of the elements (10a . . . 10n, 20a . . . 20n) comprise carbon material.
7. Frame device (100), characterized in that the retaining element (60) is arranged between a motor (240) and the fuel cell stack (220) of the propulsion unit (200a . . . 200n).
8. Frame device (100), characterized by rail elements (13a . . . 13n) being arranged between at least some of the annular elements (10a . . . 10n) in a front section of the frame device (100), by means of which the electrical energy storage (230) and/or the fuel cell stack (220) are arrangeable inside the frame device (100).
9. Frame device (100), further comprising a fixing strap for fixing the fuel tank (210) of the propulsion unit (200a . . . 200n) inside the frame device (100).
10. Frame device (100), further comprising an arrangement of an ESC arming switch (270) of the propulsion unit (200a . . . 200n).
11. Frame device (100), characterized in that the mounting device (40a, 40b) comprises flat elements on top being shaped essentially parallel to a surface of the cowling elements (50a . . . 50n).
12. Frame device (100), characterized in that the mounting device (40a . . . 40n) is made of steel, glass or carbon composite material or aluminum.
13. Frame device (100), characterized in that a pressure controller (250) is arrangeable rearwards at at least one of the annular elements (10a . . . 10n) of the frame device (100).

### REFERENCE LIST

10a . . . 10n annular elements
11 bulkhead
13a . . . 13n rail element
20a fixing elements
30a . . . 30n stringer element
40 mounting device
41a, 41b horizontal plate
50a . . . 50n cowling elements
51 air inlet
60 retaining element
100 frame device
200a . . . 200n propulsion unit
210 fuel tank
220 fuel cell stack
230 electric energy storage
240 motor
250 propeller
260 pressure controller
270 ESC arming switch
300 flight device
310 main lifting surface
320 tail lifting surface
330 fuselage
340 landing gear
350-380 propeller
x, y, Z cartesian coordinates

1. A frame device for a propulsion unit of a flight device, comprising:
annular elements for a fixation of a fuel tank of the propulsion unit;
a retaining element arranged between at least two of the annular elements for bearing an electrical energy storage and a fuel cell stack of the propulsion unit;
fixing elements a for fixing the annular elements in a longitudinal alignment of the frame device; and
a mounting device fixed to at least one of the fixing elements for mounting the frame device to a main lifting surface of the flight device.

2. The frame device according to claim 1, wherein foam material is arranged between at least two of the annular elements arranged side by side.

3. The frame device according to claim 1, further comprising cowling elements by means of which the propulsion unit inside the frame device is coverable.

4. The frame device according to claim 1, wherein the annular elements and the retaining elements are at least partially fixed by means of a substance-to-substance bond.

5. The frame device according to claim 4, wherein the substance-to-substance bond is realized by welding, fastening and/or gluing.

6. The frame device according to claim 1, wherein at least some of the annular elements or at least some of the fixing elements comprise aluminum, glass or carbon composite material.

7. The frame device according to claim 1, wherein the retaining element is arranged between a motor and the fuel cell stack of the propulsion unit.

8. The frame device according to claim 1, further comprising rail elements arranged between at least some of the annular elements in a front section of the frame device, by means of which the electrical energy storage and/or the fuel cell stack are arrangeable inside the frame device.

9. The frame device according to claim 1, further comprising a fixing strap for fixing the fuel tank of the propulsion unit inside the frame device.

10. The frame device according to claim 1, further comprising an arrangement of an ESC arming switch of the propulsion unit.

11. The frame device according to claim 3, wherein the mounting device comprises flat elements on top shaped essentially parallel to a surface of the cowling elements.

12. The frame device according to claim 1, wherein the mounting device is made of steel, glass or carbon composite material or aluminum.

13. The frame device according to claim 1, wherein a pressure regulator is arrangeable rearwards at at least one of the annular elements of the frame device.
